(19) United States
(12) Patent Application Publication
(10) Pub. No.: US 2026/0342086 A1
(43) Pub. Date: Oct. 29, 2026

(54) SYSTEMS AND METHODS FOR MONITORING AND CONTROLLING TRANSFORMER LOAD

(71) Applicant: DUKE ENERGY CORPORATION, Charlotte, NC (US)

(72) Inventors: Jay William OLIVER, Landrum, SC (US); Jon LANDY, Charlotte, NC (US); Ashley COLEMAN, Charlotte, NC (US); Steven Patrick HINKEL, California, KY (US); James Douglas CLEVELAND, Charlotte, NC (US); Bruce M. HOBAN, Charlotte, NC (US)

(21) Appl. No.: 19/655,609

(22) Filed: Apr. 22, 2026

Related U.S. Application Data
(60) Provisional application No. 63/794,076, filed on Apr. 24, 2025.

(51) Int. Cl. H02J 3/12; B60L 55/00; H02J 13/12; H02J 13/13; H02J 13/16; H02J 13/18; H02J 105/42; H02J 105/50; H02J 105/52; H02J 105/54; H02J 107/20

(52) U.S. Cl. CPC H02J 3/12; H02J 13/12; H02J 13/1331; H02J 13/16; H02J 13/18; B60L 55/00; H02J 2105/42; H02J 2105/51; H02J 2105/52; H02J 2105/54; H02J 2107/20

(57) ABSTRACT

A system for monitoring and controlling load on a distribution transformer providing electrical power to a plurality of customer premises includes a transformer load coordinator (TLC) electrically connected to the distribution transformer, and a plurality of home load coordinators (HLC). Each HLC is located at a respective one of the plurality of customer premises and is in communication with the TLC and with at least one electrical appliance at the respective one of the plurality of customer premises. The TLC is configured to monitor transformer load and to transmit a load shed signal to each HLC in response to transformer load exceeding a threshold level for a predetermined period of time. Each HLC is configured to communicate with the at least one electrical appliance and direct the at least one electrical appliance to reduce load in response to receiving the load shed signal from the TLC.

### RELATED APPLICATION

This application claims the benefit of and priority to U.S. Provisional Patent Application No. 63/794,076 filed Apr. 24, 2025, the disclosure of which is incorporated herein by reference as if set forth in its entirety.

### FIELD OF THE INVENTION

The present invention relates generally to an electrical power grid and, more particularly, to electrical power grid transformers.

### BACKGROUND OF THE INVENTION

An electric power grid is a complex network that delivers electricity from generating sources to end consumers, such as residential and commercial consumers, and includes a transmission system and a distribution system. The transmission system transports large amounts of electricity over long distances from a generating source to transmission substations via high-voltage transmission lines. Transmission substations typically connect multiple transmission lines and contain equipment configured to switch lines and convert between transmission voltages. The distribution system delivers electricity from the transmission substations to individual customers. The distribution system includes distribution substations that “step down” the voltage of the electricity and transmit the reduced voltage electricity to distribution transformers that are electrically connected to each customer's premise. Distribution transformers are typically pole-mounted or pad-mounted transformers that further reduce voltage before delivery to a customer premise.

With the increasing popularity of motor vehicles that rely on electricity for some or all of their propulsion, it has become necessary to provide electrical supply capabilities that are suitable for these vehicles. Unfortunately, the electric power grid may become strained with the growing consumer demand for electricity, and the need for electric vehicle (EV) chargers is exacerbating this demand. For example, EV charging has the potential to increase peak electricity demand, especially in the evenings when people return home from work and plug in their vehicles. This may coincide with existing peak residential electricity usage, which may overload the electric power grid. In addition to electric vehicle chargers, other devices and appliances, such as water heaters, pool pumps, and air conditioners can increase peak electricity demand and strain the electric power grid.

Replacing existing distribution transformers with higher capacity transformers to satisfy increased demand may be costly and may require a long lead time from when an order is placed to when a new transformer can be installed. As such, it would be desirable to utilize existing distribution transformers as long as possible in the face of increasing consumer demand for electric power.

### SUMMARY OF THE INVENTION

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to some embodiments of the present invention, a system for monitoring and controlling load on a distribution transformer providing electrical power to a plurality of customer premises includes a transformer load coordinator (TLC) electrically connected to the distribution transformer, and a plurality of home load coordinators (HLC). Each HLC is located at a respective one of the plurality of customer premises and is in communication with the TLC and with at least one electrical appliance at the respective one of the plurality of customer premises. The TLC is configured to monitor transformer load and to transmit a load shed signal to each HLC in response to transformer load exceeding a threshold level for a predetermined period of time. Each HLC is configured to communicate with the at least one electrical appliance and direct the at least one electrical appliance to reduce load in response to receiving the load shed signal from the TLC.

For example, in some embodiments, the at least one electrical appliance is an electric vehicle (EV) charger, and the HLC is configured to direct a controller associated with the EV charger to delay charging, pause charging or reduce an amount of electrical power drawn by the EV charger. In some embodiments, the at least one electrical appliance is an electric water heater, and the HLC is configured to direct a controller associated with the electric water heater to pause heating. In some embodiments, the at least one electrical appliance is an electric heat pump, and the HLC is configured to adjust a thermostat associated with the electric heat pump such that the electric heat pump pauses heating or cooling.

The TLC includes a monitoring device configured to provide continuous real-time measurement of at least one electrical parameter of the distribution transformer that is indicative of transformer load and/or at least one thermal parameter of the distribution transformer that is indicative of transformer load. For example, electrical parameters that can be measured include, but are not limited to, voltage, current, power factor, and frequency. Thermal parameters that can be measured include, but are not limited to, transformer oil temperature, and ambient temperature. In some embodiments, the TLC is configured to communicate the at least one electrical parameter and the at least one thermal parameter to a control center of an electric utility operating an electric grid to which the distribution transformer is attached.

In some embodiments, the TLC includes a radio transmitter configured to transmit the load shed signal to each HLC, and each HLC comprises a radio receiver configured to receive the load shed signal from the TLC. In some embodiments, each HLC is in wireless communication with the at least one electrical appliance.

In some embodiments, the at least one electrical appliance is an EV charger, and an HLC may include a processor and an electric meter in communication with the processor that is configured to monitor utilization of the EV charger such that the processor is configured to learn EV charging patterns at the respective customer premise.

In some embodiments, the TLC may be configured to monitor a local electric grid to which the distribution transformer is connected and to identify a grid event requiring the distribution transformer to shed load. In response to identifying a grid event, the TLC is configured to transmit a second load shed signal to each HLC.

In some embodiments, the TLC is configured to monitor transformer load and to transmit a load increase signal to each HLC in response to transformer load being below the threshold level for a second predetermined period of time, and each HLC is configured to communicate with the at least one electrical appliance and direct the at least one electrical appliance to increase load in response to receiving the load increase signal from the TLC.

According to some embodiments of the present invention, a method of monitoring and controlling load on a distribution transformer providing electrical power to a customer premise is provided. A transformer load coordinator (TLC) is electrically connected to the distribution transformer, and a home load coordinator (HLC) is located at the customer premise and is in communication with the TLC and with at least one electrical appliance at the customer premise. The method includes monitoring distribution transformer load via the TLC; transmitting, via the TLC, a load shed signal to the HLC in response to transformer load exceeding a threshold level for a predetermined period of time; and directing, via the HLC, the at least one electrical appliance to reduce load in response to the HLC receiving the load shed signal from the TLC. For example, the at least one electrical appliance may be an electric vehicle (EV) charger, and the method includes directing, via the HLC, a controller associated with the EV charger to pause charging or to reduce an amount of electrical power drawn by the EV charger. The at least one electrical appliance may be an electric water heater, and wherein the method includes directing, via the HLC, a controller associated with the electric water heater to pause heating. The at least one electrical appliance may be an electric heat pump, and the method includes adjusting, via the HLC, a thermostat associated with the electric heat pump such that the electric heat pump pauses heating or cooling.

Monitoring the distribution transformer load may include measuring in real-time at least one electrical parameter of the distribution transformer and/or at least one thermal parameter of the distribution transformer, wherein the at least one electrical parameter and the at least one thermal parameter are indicative of transformer load. For example, the at least one electrical parameter may be one or more of the following: voltage, current, power factor, and frequency, and the at least one thermal parameter may be one or more of the following: transformer oil temperature, and ambient temperature.

In some embodiments, the method includes transmitting, via the TLC, the at least one electrical parameter and the at least one thermal parameter to a control center of an electric utility operating an electric grid to which the distribution transformer is attached.

In some embodiments, the at least one electrical appliance is an EV charger, and the method includes monitoring utilization of the EV charger via an electric meter associated with an HLC, and identifying EV charging patterns at the respective customer premise via a processor associated with the HLC.

In some embodiments, the method also includes monitoring, via the TLC, a local electric grid to which the distribution transformer is connected and identifying a grid event requiring the distribution transformer to shed load; and transmitting, via the TLC, a second load shed signal to each HLC in response to identifying the grid event.

### BRIEF DESCRIPTION OF THE DRAWINGS

The accompanying drawings, which form a part of the specification, illustrate various embodiments of the present invention. The drawings and description together serve to fully explain embodiments of the present invention.

FIG. 1 illustrates a system, according to some embodiments of the present invention, that is configured to monitor a distribution transformer and to autonomously direct one or more of a group of devices receiving electrical power from the transformer to shed load in response to the transformer load reaching a predetermined peak setpoint and/or the internal temperature of the transformer reaching a predetermined temperature threshold.

FIG. 2 illustrates components of a Transformer Load Coordinator (TLC) according to some embodiments of the present invention.

FIG. 3 illustrates components of a Home Load Coordinator (HLC) according to some embodiments of the present invention.

FIG. 4 is a block diagram illustrating communications between a TLC and a plurality of HLCs, and communications between a TLC and an electric utility, according to some embodiments of the present invention.

FIG. 5 is a block diagram illustrating data flow between a distribution transformer and a TLC, and between an HLC and a plurality of EV chargers, according to some embodiments of the present invention.

FIG. 6 is a flowchart of operations performed by the system of FIG. 1, according to some embodiments of the present invention.

FIG. 7 is a block diagram that illustrates details of an exemplary processor and memory that may be used to implement various functions of a TLC, according to some embodiments of the present invention.

FIG. 8 is a block diagram that illustrates details of an exemplary processor and memory that may be used to implement various functions of an HLC, according to some embodiments of the present invention.

### DETAILED DESCRIPTION OF THE INVENTION

The present invention will now be described more fully hereinafter with reference to the accompanying figures, in which embodiments of the present invention are shown. The present invention may, however, be embodied in many different forms and should not be construed as limited to the embodiments set forth herein.

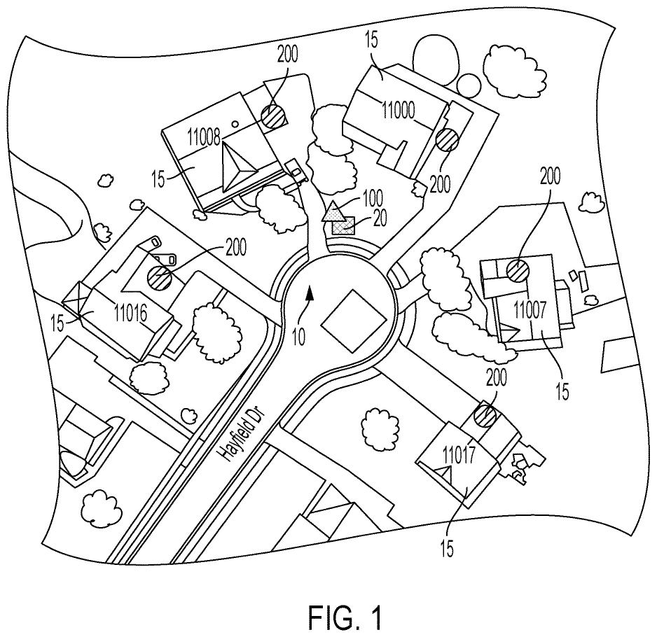

FIG. 1 illustrates a system 10 that is configured to monitor a distribution transformer 20 in a residential setting and to autonomously direct one or more of a group of devices receiving electrical power from the transformer 20, such as EV chargers and electric appliances, to shed load in response to the transformer load reaching a predetermined peak setpoint and/or the internal temperature of the transformer 20 reaching a predetermined temperature threshold. Although illustrated in a residential setting, embodiments of the present invention may also be utilized in a commercial setting where a distribution transformer 20 provides electric power to a plurality of commercial premises.

The term “load”, as used herein with respect to a distribution transformer, refers to the amount of electrical power the distribution transformer is supplying to customers at a given time, usually measured in kVA or kW.

The term “shed load”, as used herein, means to intentionally decrease the demand for electrical power by an EV charger or other electrical appliance, either automatically or manually. For example, load can be shed by turning off or cycling electrical appliances (e.g., HVAC systems, water heaters, pool pumps, etc.), turning off EV chargers or reducing the amount of power drawn by EV charger, temporarily shutting down non-critical equipment, adjusting thermostats slightly (e.g., raising the cooling temperature or lowering the heating temperature).

The system 10 includes a transformer load coordinator (TLC) 100 that is connected to the distribution transformer 20, and a plurality of home load coordinators (HLC) 200, each of which is connected to a respective residential electrical circuit of a customer's premise 15. The purpose of the TLC 100 is to monitor the transformer 20 for excessive load and/or temperature, and also to be aware of electrical grid events. For example, the transformer 20 may have a load peak setpoint of 240 kilovolt-amperes (kVA). If the load at the transformer 20 approaches or exceeds this setpoint, the TLC 100 is configured to direct one or more of the HLCs 200 to control one or more devices to shed load at a respective customer premise 15.

For example, an EV charger at a customer premise 15 could be directed to shed load by a respective HLC 200. In addition to EV chargers, each HLC 200 may be configured to control other devices to shed load, including electric HVAC systems, electric water heaters, electric pool pumps, etc.

Similarly, an example internal transformer temperature threshold could be 95 °C, and if the internal temperature of the transformer 20 approaches or exceeds this threshold, the TLC 100 is configured to direct one or more of the HLCs 200 to control one or more devices to shed load at a respective customer premise. Various transformer load setpoints and internal temperature thresholds may be utilized, and embodiments of the present invention are not limited to any particular load setpoint or internal temperature threshold.

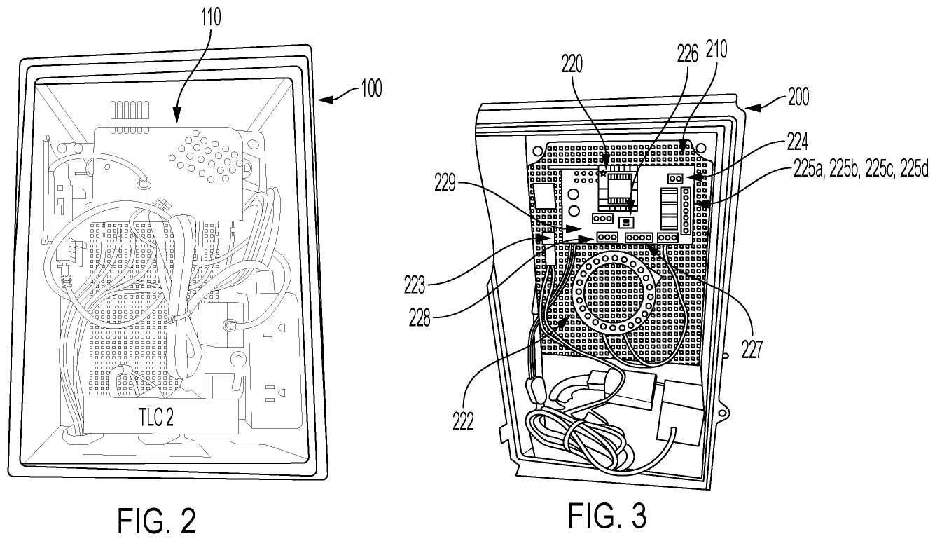

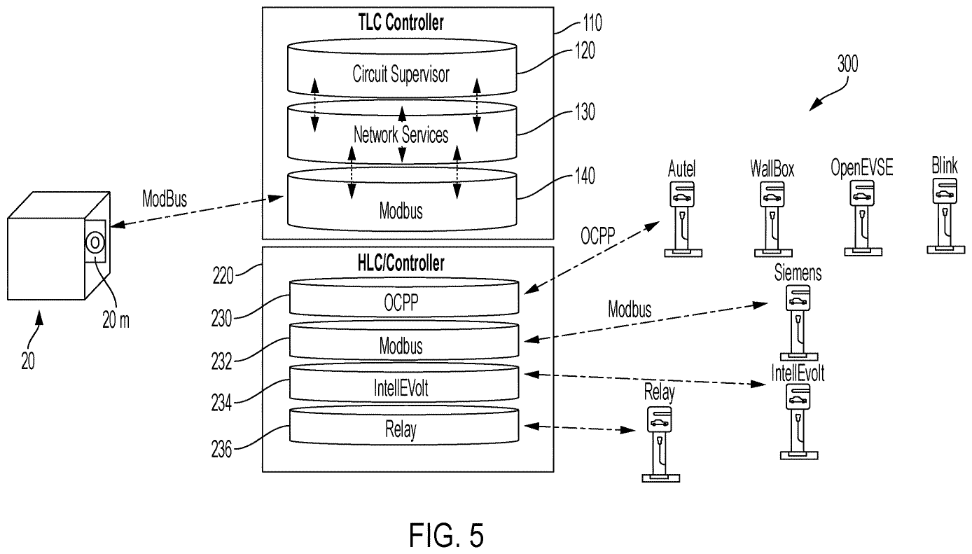

The internal components of an exemplary TLC 100, according to some embodiments of the present invention, are illustrated in FIG. 2 and include a Raspberry Pi 5 single-board computer 110 with non-volatile storage, such as a 128 GB SD (secure digital) card, a microcontroller (e.g., a ESP 32 HiLetGo microcontroller) with a 900 MHz radio, a transformer monitoring device or meter 20m (FIG. 5), a circuit supervisor (120, FIG. 5), and optionally a cellular modem. The SD card in the computer 110 stores the operating system, such as Raspberry Pi OS, and stores all files, programs, and settings. The microcontroller and 900 MHz radio are configured to send data wirelessly from the Raspberry Pi computer 110, which serves as the central hub for processing.

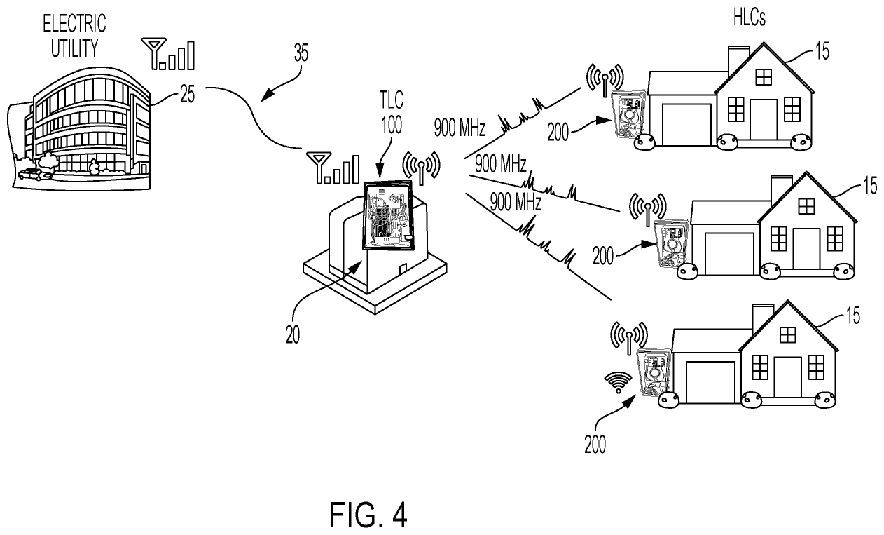

The transformer meter 20m is configured to provide continuous real-time monitoring of critical transformer parameters including key electrical and thermal parameters of the distribution transformer 20. For example, electrical parameters that can be monitored by the transformer meter 20m include, but are not limited to, voltage, current, power factor, and frequency. Thermal parameters that can be monitored by the transformer meter 20m include, but are not limited to, transformer oil temperature, and ambient temperature. Mechanical indicators that can be monitored also by the transformer meter 20m in some embodiments include, but are not limited to, transformer tilt, vibration, and tamper status. In some embodiments, the TLC 100 may be configured to transmit the monitored parameters via radio or cellular to a control center 25 of an electric utility, as indicated by 35 in FIG. 4.

The circuit supervisor 120 is a microprocessor-based device that monitors health of the transformer 20 and is configured to prepare commands for HLCs 200 that are associated with the TLC 100. In addition, the circuit supervisor is configured to monitor the local electrical grid associated with the transformer 20 and identify various electrical grid level events, such as “Normal” (i.e., no interruptions or managed load), “Green” (i.e., high renewable production, “Yellow” (i.e., partial/soft load shed is required), and “Red” (i.e., non-optional load shed is required). For example, an EV would charge 100% at Normal-Green and 50% at Yellow and 0% at Red.

The internal components of an exemplary HLC 200, according to some embodiments of the present invention, are illustrated in FIG. 3 and include a controller board 210 (e.g., an eLimXR proprietary board), which provides monitoring and control of the home loads and associated power supply equipment, an ESP32 HiLetGo microcontroller 220 with a 900 MHz radio; a meter for an EV charger mains, switches to control loads and facilitate self-healing, a relay for autonomous reboot and self-healing, an LED customer feedback ring 222, a customer override load shed event button 224, and a dipswitch 226. The LED customer feedback ring 222 is configured to indicate to a customer what grid level event is currently present.

Grid level “green” will display green on the LED ring, grid level “yellow” will display yellow on the LED ring, grid level “red” will display red on the LED ring, etc. Grid level “green” means normal, stable operating conditions, and electric power supply is adequate, reserves are sufficient, and no emergency action is needed. Grid level “yellow” means a caution or watch condition where electric power supply is tight but not yet in an immediate outage state. Grid level “red” means the electric grid is in a serious emergency condition. For example, electric power supply is very tight, reliability is at risk, and controlled outages or load shedding may be imminent or already occurring.

The customer override shed event button 224 allows a customer to “opt out” of a grid level event, resuming full charging of vehicle, as an example. The dipswitch 226 is a configuration switch and it enables the different control methods appropriate to the installed hardware. The dipswitch 226 in each HLC 200 is set by an installer during installation of the HLC 200 in a customer's premise. The dipswitch 226 is set by the installer to indicate what kind of hardware the HLC 200 is controlling, for example the type of EV charger, etc.

The illustrated HLC 200 also includes four transistors 225a, 225b, 225c, 225d, such as MOSFETs (Metal-Oxide-Semiconductor Field-Effect Transistor), that are utilized as switches to turn on and off load. For example MOSFET 1 (225a) can control EV Charger 1; MOSFET 2 (225b) can control EV Charger 2; MOSFET 3 (225c) and 4 (225d) are for future capabilities, such as an electric water heater, an electric HVAC system, an electric pool pump, etc.

The illustrated HLC 200 also includes an onboard meter 227 than can determine if an EV is actively charging, or if the EV charger is sitting idle. This meter is not utilized for billing the customer, but rather for utilization of the charging station. The meter 227 provides the ability to learn charging patterns of a customer, if the customer agrees. This will allow for the prediction of future charging and future distribution transformer 20 constraints.

The illustrated HLC 200 also includes a temperature monitoring connection 228 that allows a temperature sensor to be connected thereto to monitor the health of the HLC 200. Excessive temperatures of the HLC 200 can shorten the life of the components of the HLC 200.

Power, such as 12 volts DC power, is provided to the HLC 200 via power port 229. The HLC 200 also includes a diagnostic port 223 to which monitoring equipment can be hooked up in order to monitor the health of the HLC 200 and diagnose problems with the HLC 200.

“Self-healing” as used herein means that an HLC 200 can reset (i.e., reboot) itself if it cannot communicate properly with the TLC 100 or with an EV charger or other device/appliance.

In addition, each HLC 200 can be configured to stage how EV chargers come back on after being turned off so as not to overload the transformer 20. For example, the EV chargers at selected customer premises can be directed to come back on, and then the EV chargers at other selected customer premises can be directed to come back on (e.g., odd address numbers and then even address numbers of customer premises, etc.)

In some embodiments, an HLC 200 may include additional on/off switches that can be used to control other devices, such as water heaters, smart outlets, pool pumps, etc.

Each HLC 200 supports the following four methods of shedding EV load: Relay, OCPP (Open Charge Point Protocol), ModBus, and IntelleVolt. The four different methods provide flexibility to work with any standard Level 2 EV charger. The dipswitch 226 is how each HLC 200 knows which load shed strategy to employ. For example, if an EV charger at a customer premise does not have WiFi capability or a web-based application, the HLC 200 can control via the Relay method. Conversely if an EV charger at a customer premise is newer and is networked (e.g., has WiFi, an App, etc.) the HLC 200 can then control via OCPP.

Relay is an on/off switch that can turn on and off an EV charger. When an electrical grid level event is “Green”, Relay allows for EV charging up to 100%. When an electrical grid level event is “Yellow”, Relay is configured to delay the start of EV charging. When an electrical grid level event is “Red”, Relay is configured to allow 0% EV charging.

OCPP is an industry standard communication protocol specifically designed for EV charging infrastructure, and enables interoperability between EV charging stations and central management systems. OCPP also allows for variable control of a charge rate. ModBus is a communication protocol that allows electronic devices to transmit data over serial lines, Ethernet, or wireless. IntelleVolt is a proprietary control method that allows variable control of any Level 2 EV charger. IntelleVolt is described in U.S. patent application Ser. No. 18/808,223, which is incorporated by reference herein in its entirety. The HLC microcontroller 220 with the 900 MHz radio receives a 900 MHz signal from the TLC 100 and then determines what mode the dipswitch 226 is in and, thus, which control method to use. If the dipswitch mode is “Relay”, then the microcontroller 220 energizes a MOSFET channel to activate relay open. If the dipswitch mode is “OCPP”, then the microcontroller 220 sends commands via web sockets to the EV charger associated with the HLC 200. If the dipswitch mode is “ModBus”, then the microcontroller 220 sends commands via a serial connection to the EV charger associated with the HLC 200. If the dipswitch mode is “IntelleVolt”, then an auxiliary control board is commanded to reduce load at the EV charger associated with the HLC 200.

Referring to FIG. 4, the communication architecture for the system 10 of FIG. 1, according to some embodiments, is illustrated. The TLC 100 communicates with each HLC 200 via a 900 MHz radio. As known to those of skill in the art, a 900 MHz radio is a wireless communication device that operates in the 902-928 MHz frequency range, and which is part of the Industrial, Scientific, and Medical (ISM) band. Optionally, the TLC 100 may include cellular communications capabilities to allow the TLC 100 to communicate with an electric utility's central control system(s) 25. In addition, one or more HLCs 200 may have WiFi communications capabilities so as to be able to communicate with WiFi enabled devices and appliances at a customer premise 15.

FIG. 5 is a block diagram that illustrates data flow between a transformer 20 and a TLC controller 110, and data flow between an HLC controller 220 and various EV chargers, according to some embodiments of the present invention. In the illustrated embodiment of FIG. 5, a meter 20m (e.g., located in the TLC 100) is configured to provide continuous real-time monitoring of critical transformer parameters such as voltage, current, power factor, and temperature to the TLC controller 110 of the TLC 100 associated with the distribution transformer 20. The TLC controller 110 includes a circuit supervisor module 120, a network services module 130, and a ModBus module 140. The transformer data is transferred to the ModBus module 140 in the TLC controller via ModBus communication protocol. The TLC 100 locally communicates via 900 mhz radio to each HLC 200 and, optionally if a cell modem is present, IP (internet protocol) over cellular backhaul.

The Circuit Supervisor module 120 processes the data from the transformer meter 20m and determines where and what loads require shedding. The Circuit Supervisor module 120 then sends control signals to the HLC controller 220 of one or more HLCs 200 that direct the one or more HLCs 200 to cause an EV charger or other appliance/device to shed load. The HLC controller 220 includes an OCPP module 230, a ModBus module 232, and IntelleVolt module 234, and a Relay module 236. The OCPP module 230 is used to control a first group of EV chargers (i.e., an Autel, WallBox, OpenEVSE, and Blink EV chargers) to shed load. The ModBus module 232 is used to control a Siemens EV charger to shed load. The IntelleVolt module 234 is used to control an IntelleVolt EV charger to shed load. The Relay module 236 is used to control a Relay EV charger to shed load as well as self-healing and cold load pickup.

Embodiments of the present invention are not limited for use with any particular type of EV chargers. Various types of EV chargers including, but not limited to, level 1 and level 2 chargers, and EV chargers from various manufacturers may be controlled by the system 10 without limitation.

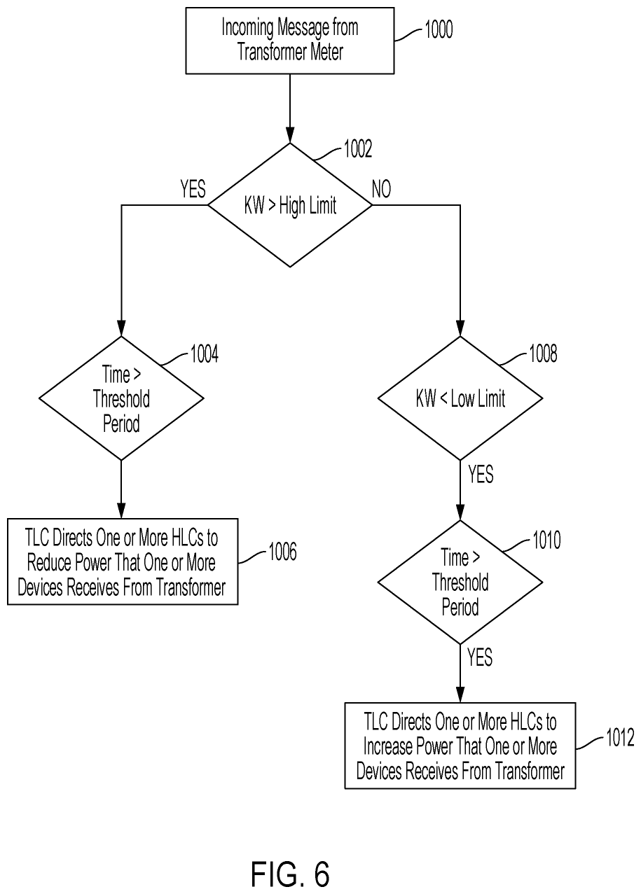

FIG. 6 is a flowchart of some operations performed by the system 10 illustrated in FIGS. 1-5. A message from the meter 20m associated with the transformer 20 is received at the TLC controller 110 (Block 1000). The TLC controller 110 determines from the received message whether the transformer load has exceeded a threshold load level (Block 1002). If the answer at Block 1002 is “Yes”, the TLC controller 110 determines if an amount of time the transformer load has exceeded the threshold load level is greater than a predetermined amount of time (Block 1004). If the answer at Block 1004 is “Yes”, the TLC controller 110 directs one or more HLC controllers 220 to reduce the amount of electrical power one or more of the EV chargers 300 (or other electrical appliances) receives from the transformer 20, including turning off power completely to one or more of the EV chargers 300 (Block 1006). If the answer at Block 1004 is “No”, the system 10 waits until the answer is “Yes”.

If the answer at Block 1002 is “No”, the TLC controller 110 determines whether the transformer load is below a lower load limit (Block 1008). If the answer at Block 1008 is “No”, the system 10 waits until the answer is “Yes”. If the answer at Block 1008 is “Yes”, the TLC controller 110 determines if an amount of time the transformer load has been below the lower threshold load level is greater than a predetermined amount of time (Block 1010). If the answer at Block 1010 is “Yes”, the TLC controller 110 directs the one or more HLC controllers 220 to increase the amount of electrical power one or more of the EV chargers 300 (or other electrical appliances) receives from the transformer 20 (Block 1012).

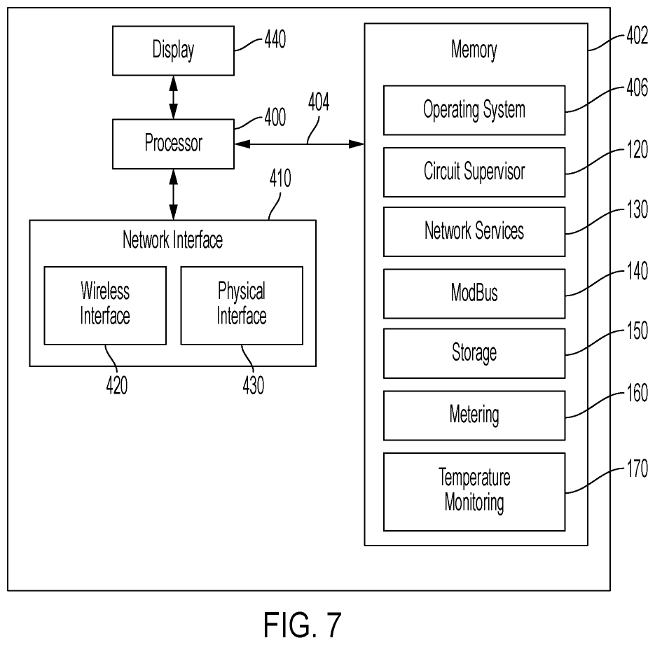

FIG. 7 is a block diagram that illustrates details of an exemplary processor 400 and memory 402 that may be used to implement various functions of a TLC controller 110, according to some embodiments of the present invention. The processor 400 communicates with the memory 402 via an address/data bus 404. The processor 400 may be, for example, a commercially available or custom microprocessor. Moreover, the processor 400 may include multiple processors. The memory 402 may be a non-transitory computer readable storage medium and may be representative of the overall hierarchy of memory devices containing the software and data used to implement various functions of the TLC controller 110 as described herein. The memory 402 may include, but is not limited to, the following types of devices: cache, ROM, PROM, EPROM, EEPROM, flash, static RAM (“SRAM”), and dynamic RAM (“DRAM”).

The memory 402 may hold various categories of software (i.e., computer readable program code) and data, such as an operating system 406, a Circuit Supervisor module 120, a Network Services module 130, a ModBus module 140, a Storage module 150, a Metering module 160, a Temperature Monitoring module 170, and to perform any of the operations described herein. The operating system 406 manages the resources of the TLC controller 110 and may coordinate execution of various programs (e.g., the Circuit Supervisor module 120, the Network Services module 130, the ModBus module 140, the Storage module 150, the Metering module 160, the Temperature Monitoring module 170) by the processor 400. The operating system 406 can be any operating system suitable for use with a data processing system, such as Microsoft® Windows® operating systems, iOS®, Android®, Unix or Linux™, etc.

The Circuit Supervisor module 120 comprises logic for processing data from the transformer meter 20m and generating control signals for one or more HLCs 200 for the purpose of shedding load at one or more customer premises 15.

The Network Services module 130 comprises logic for the TLC 100 to locally communicate at 900 mhz to the HLCs 200 and, optionally, if a cell modem is present, to communicate IP over cellular backhaul.

The ModBus module 140 comprises logic for receiving data from the transformer meter 20m and meters the transformer load.

The Storage module 140 comprises logic for storing transformer temperature data and transformer load data provided by the Metering module 160 and Temperature Monitoring module 170, described below.

The Metering module 160 comprises logic for reading the load (kVA) of the transformer 20 and for storing these load readings in the Storage module 140. The Metering module 160 also comprises logic for sending alerts to the electrical grid operator when the transformer 20 is nearing capacity (i.e., threatening reliability).

The Temperature module 170 comprises logic for monitoring the temperature of the transformer 20 and storing this temperature data in the Storage module 150. This stored temperature data allows the processor 400 to generate a temperature profile of the transformer 20, and provides the processor 400 with data with which future predictions about the temperature of the transformer 20 can be made.

The processor 400 is coupled to a network interface 410, which allows the processor 400 to communicate with the transformer meter 20m. For example, the network interface 410 may include one or more wireless interfaces 420 and/or one or more physical interfaces 430. The wireless interface(s) 420 may comprise wireless communications circuitry, such as BLUETOOTH® circuitry, cellular communications circuitry that provides a cellular wireless interface (e.g., 4G/5G/LTE, other cellular), Wi-Fi circuitry and/or radio circuitry (e.g., 900 MHz). The physical interface(s) 430 may comprise wired communications circuitry, such as wired Ethernet, serial.

The processor 400 may also be coupled to a display 440 that is configured to display various information, such as information from sensors associated with the transformer 20.

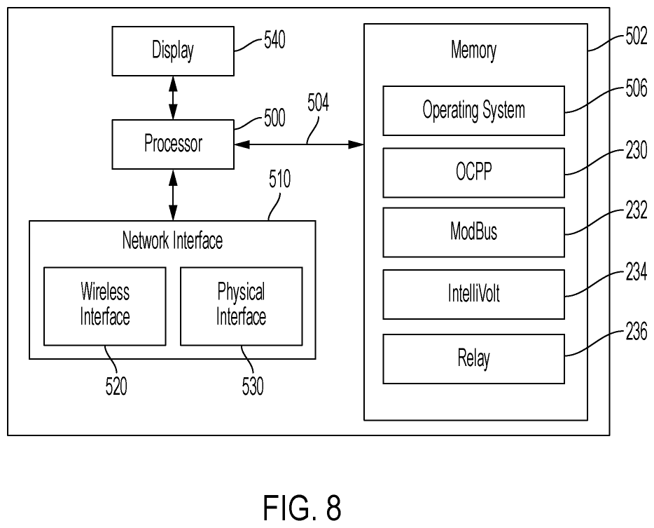

FIG. 8 is a block diagram that illustrates details of an exemplary processor 500 and memory 502 that may be used to implement various functions of an HLC controller 220, according to some embodiments of the present invention. The processor 500 communicates with the memory 502 via an address/data bus 404. The processor 500 may be, for example, a commercially available or custom microprocessor. Moreover, the processor 500 may include multiple processors. The memory 502 may be a non-transitory computer readable storage medium and may be representative of the overall hierarchy of memory devices containing the software and data used to implement various functions of the HLC controller 220 as described herein. The memory 502 may include, but is not limited to, the following types of devices: cache, ROM, PROM, EPROM, EEPROM, flash, static RAM (“SRAM”), and dynamic RAM (“DRAM”).

The memory 502 may hold various categories of software (i.e., computer readable program code) and data, such as an operating system 506, an OCPP module 230, a ModBus module 232, an IntelleVolt module 234, a Relay module 236, and to perform any of the operations described herein. The operating system 506 manages the resources of the HLC controller 220 and may coordinate execution of various programs (e.g., the OCPP module 230, the ModBus module 232, the IntelleVolt module 234, the Relay module 236) by the processor 500. The operating system 506 can be any operating system suitable for use with a data processing system, such as Microsoft® Windows® operating systems, iOS®, Android®, Unix or Linux™, etc.

The OCPP module 230 comprises logic for communicating with and sending control signals to a certain subgroup of EV chargers, e.g., Autel chargers, WallBox chargers, OpenEVSE chargers, and Blink chargers. The ModBus module 232 comprises logic for communicating with and sending control signals to Siemens chargers. The IntelleVolt module 234 comprises logic for communicating with and sending control signals to IntelleVolt chargers. The Relay module 236 comprises logic for communicating with and sending control signals to Relay chargers. Other modules may be provided that comprise logic for communicating with and sending control signals to other electrical appliances.

The processor 500 is coupled to a network interface 510, which allows the processor 500 to communicate with the various EV chargers and other devices/appliances at a customer premise 15. For example, the network interface 510 may include one or more wireless interfaces 520 and/or one or more physical interfaces 530. The wireless interface(s) 420 may comprise wireless communications circuitry, such as BLUETOOTH® circuitry, cellular communications circuitry that provides a cellular wireless interface (e.g., 4G/5G/LTE, other cellular), Wi-Fi circuitry and/or radio circuitry (e.g., 900 MHz). The physical interface(s) 530 may comprise wired communications circuitry, such as wired Ethernet, and serial circuitry. The processor 500 may also be coupled to a display 540 that is configured to display various information.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity. The term “and/or” includes any and all combinations of one or more of the associated listed items.

Like numbers refer to like elements throughout. In the figures, certain components or features may be exaggerated for clarity, and broken lines may illustrate optional features or operations unless specified otherwise. In addition, the sequence of operations (or steps) is not limited to the order presented in the figures and/or claims unless specifically indicated otherwise. Features described with respect to one figure or embodiment can be associated with another embodiment or figure although not specifically described or shown as such.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected”, “coupled”, “responsive”, or variants thereof to another element, it can be directly connected, coupled or responsive to the other element or intervening elements may be present. In contrast, when an element is referred to as being “directly connected”, “directly coupled”, “directly responsive”, or variants thereof to another element, there are no intervening elements present. Other words used to describe the relationship between elements should be interpreted in a like fashion (i.e., “between” versus “directly between”, “adjacent” versus “directly adjacent”, etc.).

As used herein, the singular forms “a”, “an” and “the” are intended to include the plural forms as well, unless the context clearly indicates otherwise. As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.,” which derives from the Latin phrase “exempli gratia,” may be used to introduce or specify a general example or examples of a previously mentioned item, and is not intended to be limiting of such item. The common abbreviation “i.e.,” which derives from the Latin phrase “id est,” may be used to specify a particular item from a more general recitation.

It will be understood that although the terms first, second, third, etc., may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of the present invention. The same reference numerals or the same reference designators denote the same or similar elements throughout the specification.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terms “about” and “approximately”, as used herein with respect to a value or number, is meant to encompass variations of ±10%, ±5%, ±1%, ±0.5%, or even ±0.1% of the specified value as well as the specified value. For example, “about X” where X is the measurable value, is meant to include X as well as variations of ±10%, ±5%, ±1%, ±0.5%, or even ±0.1% of X. A range provided herein for a measurable value may include any other range and/or individual value therein.

The terms “EV charging station”, “EV charger”, and EV supply equipment (EVSE), as used herein, are interchangeable and refer to any equipment that connects an electric vehicle (EV) to a source of electricity to recharge a battery of an EV.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

What is claimed is:

1. A system for monitoring and controlling load on a distribution transformer providing electrical power to a plurality of customer premises, the system comprising:
a transformer load coordinator (TLC) electrically connected to the distribution transformer; and
a plurality of home load coordinators (HLC), wherein each HLC is located at a respective one of the plurality of customer premises and is in communication with the TLC and with at least one electrical appliance at the respective one of the plurality of customer premises,
wherein the TLC is configured to monitor transformer load and to transmit a load shed signal to each HLC in response to transformer load exceeding a threshold level for a predetermined period of time, and
wherein each HLC is configured to communicate with the at least one electrical appliance and direct the at least one electrical appliance to reduce load in response to receiving the load shed signal from the TLC.

2. The system of claim 1, wherein the TLC comprises a monitoring device configured to provide continuous real-time measurement of at least one electrical parameter of the distribution transformer and/or at least one thermal parameter of the distribution transformer, wherein the at least one electrical parameter and the at least one thermal parameter are indicative of transformer load.

3. The system of claim 2, wherein the at least one electrical parameter is selected from the following: voltage, current, power factor, and frequency, and wherein the at least one thermal parameter is selected from the following: transformer oil temperature and ambient temperature.

4. The system of claim 2, wherein the TLC is further configured to communicate the at least one electrical parameter and the at least one thermal parameter to a control center of an electric utility operating an electric grid to which the distribution transformer is attached.

5. The system of claim 1, wherein the TLC comprises a radio transmitter configured to transmit the load shed signal to each HLC, and wherein each HLC comprises a radio receiver configured to receive the load shed signal from the TLC.

6. The system of claim 1, wherein each HLC is in wireless communication with the at least one electrical appliance.

7. The system of claim 1,
wherein the at least one electrical appliance is an electric vehicle (EV) charger, and
wherein the HLC is configured to direct a controller associated with the EV charger to pause charging or to reduce an amount of electrical power drawn by the EV charger; or
wherein the at least one electrical appliance is an electric water heater, and wherein the HLC is configured to direct a controller associated with the electric water heater to pause heating; or
wherein the at least one electrical appliance is an electric heat pump, and wherein the HLC is configured to adjust a thermostat associated with the electric heat pump such that the electric heat pump pauses heating or cooling.

8. The system of claim 1, wherein the at least one electrical appliance is an EV charger, wherein each HLC comprises a processor and an electric meter in communication with the processor, wherein the electric meter is configured to monitor utilization of the EV charger, and wherein the processor is configured to learn EV charging patterns at the respective customer premise.

9. The system of claim 1, wherein the TLC is further configured to monitor a local electric grid to which the distribution transformer is connected and to identify a grid event requiring the distribution transformer to shed load, and wherein the TLC is configured to transmit a second load shed signal to each HLC in response to identifying the grid event.

10. The system of claim 1, wherein the TLC is configured to monitor transformer load and to transmit a load increase signal to each HLC in response to transformer load being below the threshold level for a second predetermined period of time, and wherein each HLC is configured to communicate with the at least one electrical appliance and direct the at least one electrical appliance to increase load in response to receiving the load increase signal from the TLC.

11. A system for monitoring and controlling load on a distribution transformer providing electrical power to a plurality of customer premises, the system comprising:
a transformer load coordinator (TLC) electrically connected to the distribution transformer; and
a plurality of home load coordinators (HLC), wherein each HLC is located at a respective one of the plurality of customer premises and is in communication with the TLC and with at least one electrical appliance at the respective one of the plurality of customer premises,
wherein the TLC is configured to monitor transformer load and to transmit a first load shed signal to each HLC in response to transformer load exceeding a threshold level for a predetermined period of time, wherein the TLC comprises a monitoring device configured to provide continuous real-time measurement of at least one electrical parameter of the distribution transformer and/or at least one thermal parameter of the distribution transformer, wherein the at least one electrical parameter and the at least one thermal parameter are indicative of transformer load,
wherein the TLC is configured to monitor a local electric grid to which the distribution transformer is connected and to identify a grid event requiring the distribution transformer to shed load, and wherein the TLC is configured to transmit a second load shed signal to each HLC in response to identifying the grid event, and
wherein each HLC is configured to communicate with the at least one electrical appliance and direct the at least one electrical appliance to reduce load in response to receiving the first load shed signal and/or the second load shed signal from the TLC.

12. The system of claim 11, wherein the TLC is further configured to monitor transformer load and to transmit a load increase signal to each HLC in response to transformer load being below the threshold level for a second predetermined period of time, and wherein each HLC is configured to communicate with the at least one electrical appliance and direct the at least one electrical appliance to increase load in response to receiving the load increase signal from the TLC.

13. The system of claim 11, wherein the at least one electrical parameter is selected from the following: voltage, current, power factor, and frequency, and wherein the at least one thermal parameter is selected from the following: transformer oil temperature and ambient temperature.

14. The system of claim 11, wherein the TLC is further configured to communicate the at least one electrical parameter and the at least one thermal parameter to a control center of an electric utility operating an electric grid to which the distribution transformer is attached.

15. The system of claim 11, wherein the TLC comprises a radio transmitter configured to transmit the first and second load shed signals to each HLC, and wherein each HLC comprises a radio receiver configured to receive the first and second load shed signals from the TLC.

16. The system of claim 11, wherein each HLC is in wireless communication with the at least one electrical appliance.

17. A method of monitoring and controlling load on a distribution transformer providing electrical power to a customer premise, wherein a transformer load coordinator (TLC) is electrically connected to the distribution transformer, and a home load coordinator (HLC) is located at the customer premise, wherein the HLC is in communication with the TLC and with at least one electrical appliance at the customer premise, the method comprising:
monitoring distribution transformer load via the TLC;
transmitting, via the TLC, a load shed signal to the HLC in response to transformer load exceeding a threshold level for a predetermined period of time; and
directing, via the HLC, the at least one electrical appliance to reduce load in response to the HLC receiving the load shed signal from the TLC.

18. The method of claim 17, wherein monitoring the distribution transformer load comprises measuring in real-time at least one electrical parameter of the distribution transformer and/or at least one thermal parameter of the distribution transformer, wherein the at least one electrical parameter and the at least one thermal parameter are indicative of transformer load.

19. The method of claim 18, wherein the at least one electrical parameter is selected from the following: voltage, current, power factor, and frequency, and wherein the at least one thermal parameter is selected from the following: transformer oil temperature and ambient temperature.

20. The method of claim 18, further comprising communicating, via the TLC, the at least one electrical parameter and the at least one thermal parameter to a control center of an electric utility operating an electric grid to which the distribution transformer is attached.

21. The method of claim 17, wherein the at least one electrical appliance is an EV charger, and wherein each HLC comprises a processor and an electric meter in communication with the processor, wherein the method further comprises monitoring utilization of the EV charger via the electric meter, and identifying charging patterns at the respective customer premise via the processor.

22. The method of claim 17,
wherein the at least one electrical appliance is an electric vehicle (EV) charger, and wherein the method comprises directing, via the HLC, a controller associated with the EV charger to pause charging or to reduce an amount of electrical power drawn by the EV charger; or
wherein the at least one electrical appliance is an electric water heater, and wherein the method comprises directing, via the HLC, a controller associated with the electric water heater to pause heating; or
wherein the at least one electrical appliance is an electric heat pump, and wherein the method comprises adjusting, via the HLC, a thermostat associated with the electric heat pump such that the electric heat pump pauses heating or cooling.

23. The method of claim 17, wherein the method further comprises:
monitoring, via the TLC, a local electric grid to which the distribution transformer is connected and identifying a grid event requiring the distribution transformer to shed load; and
transmitting, via the TLC, a second load shed signal to each HLC in response to identifying the grid event.
